(19) United States
(12) Patent Application Publication
(10) Pub. No.: US 2026/0082274 A1
(43) Pub. Date: Mar. 19, 2026

(54) METHODS FOR SUPPORTING ASSOCIATED IDENTIFICATIONS (IDs) FOR MULTI-CELLS

(71) Applicant: InterDigital Patent Holdings, Inc., Wilmington, DE (US)

(72) Inventors: Young Woo Kwak, Woodbury, NY (US); Oumer Teyeb, Montreal (CA); Moon IL Lee, Melville, NY (US); Dylan Watts, Montreal (CA); Nazli Khan Beigi, Longueuil (CA)

(73) Assignee: InterDigital Patent Holdings, Inc., Wilmington, DE (US)

(21) Appl. No.: 18/888,835

(22) Filed: Sep. 18, 2024

(51) Int. Cl. H04W 28/086; H04W 48/08

(52) U.S. Cl. CPC H04W 28/086; H04W 48/08

(57) ABSTRACT

A wireless transceiver/receiver unit (WTRU) comprises a processor configured to receive configuration information. The configuration information may include a plurality of associated identification (ID) groups, one or more associated identifiers (IDs) associated with each associated ID group of the plurality of associated ID groups, and/or a plurality sets of radio resource control (RRC) configurations, where each set of RRC configurations is associated with an associated ID. The processor may be configured to receive indication that an associated ID group of the plurality of associated ID groups is associated with one or more cells, activate a first cell using a first set of RRC configurations of the plurality of sets of RRC configurations, receive an activation message to activate a second cell, and perform an activation procedure.

### BACKGROUND

Artificial intelligence/machine learning (AI/ML) for new radio (NR) may have the following objectives for general framework and model identification. For example, an objective may be to provide specification support for AI/ML general framework for one-sided AI/ML models within the realm of what has been studied in the Feasability Study-New Radio-Artificial Intelligence-Air (FS_NR_AIML_Air) project. For instance, an objective may be to provide specification support for signalling and protocol aspects of life cycle management (LCM) enabling functionality and model (e.g., if justified) selection, activation, deactivation, switching, fallback. Identification related signalling is also part of the objective. For instance, an objective may be to provide specification support for necessary signalling/mechanism(s) for LCM to facilitate model training, inference, performance monitoring, data collection (e.g., except for the purpose of core Network/operations, administration and management/over the top (CN/OAM/OTT) collection of WTRU-sided model training data) for both WTRU-sided and NW-sided models. For instance, an objective may be to provide specification support for signalling mechanism of applicable functionalities/models. Study objectives with corresponding checkpoints may include necessity and details of model identification concept and procedure in the context of LCM. How to identify AI/ML model, applicable functionalities and/or models and support LCM may be important procedures for supporting AI/ML model in NR

To support model identification procedure via over-the-air signaling, model identification with data collection related configuration(s) and/or indication(s) may be used. For example, associate ID(s) can be used for consistency of network (NW) side additional conditions across training and inference of the WTRU side model. However, how to achieve consistency of NW side additional conditions for multiple cells is not clear. For example, whether to reuse associated IDs between multiple cells may be considered. In addition, receiving radio resource control (RRC) reconfiguration for whole AI/ML models for every cell is not efficient. To avoid frequent RRC reconfiguration, efficient RRC configuration mechanisms may be considered. For example, instead of managing one cell, enhanced life cycle management mechanism for handling multiple cells may be implemented.

In current consideration for associated ID(s), a simple scenario with a single transmission and reception point (TRP) was considered. However, benefits of AI/ML model increases when complexity of a problem that needs to be solved increases. Given the situation, more complex cell aggregation scenarios may be considered for the support of associated ID(s). For example, an embodiment for how a UE supports associate ID(s) to achieve consistency of NW side additional conditions for multi-cells may be developed.

### SUMMARY

A wireless transceiver/receiver unit (WTRU) may comprise a processor. In some examples, the processor may be configured to receive configuration information. The configuration information may include, for example, a plurality of associated identification (ID) groups, one or more associated identifiers (IDs) associated with each associated ID group of the plurality of associated ID groups, and/or a plurality sets of radio resource control (RRC) configurations, where each set of RRC configurations is associated with an associated ID. The processor may be configured to receive indication that an associated ID group of the plurality of associated ID groups is associated with one or more cells. The processor may be configured to activate a first cell using a first set of RRC configurations of the plurality of sets of RRC configurations. The processor may be configured to receive an activation message to activate a second cell. The processor may be configured to perform an activation procedure to activate the second cell based on the associated ID groups associated with the first cell and the second cell and based on the associated ID for the second cell.

In some examples, to perform the activation procedure, the processor may be configured to activate the cell using the first set of RRC reconfigurations upon a condition that the first associated ID group of the second cell may be the same as a second associated ID group of a third cell.

In some example, the third cell may be, for example, the first cell, a primary cell (Pcell) and/or a primary secondary group cell (PScell) that the WTRU received via the second activation message.

In some examples, to perform the activation procedure, the processor may be configured to activate the associated ID in accordance with a first activation time, wherein the first activation time is substantially immediately. In some examples, substantially immediately may be defined as immediately with some inherent latency.

In some examples, to perform the activation procedure, the processor may be configured to receive a delta configuration and activate the cell based on the delta configuration upon a condition that a first associated ID group is not the same as a second associated ID group.

The delta configuration may be, for example, the difference between a reference configuration and a RRC configuration to be used for the second cell.

The reference configuration may be, for example, the sets of RRC configurations associated with one or more common associated IDs associated with both the first associated ID group and the second associated ID group of the plurality of associated ID groups when a number of the one or more common associated IDs is greater than an associated ID threshold.

The reference configuration may be, for example, RRC configuration without the sets of RRC configurations associated with the one or more associated IDs when a number of one or common associated IDs associated with both the first associated ID group and the second associated ID group of the plurality of associated ID groups is less than an associated ID threshold.

In some examples, the processor may be configured to activate the associated ID with a second activation time. In some examples, the first activation time may be shorter than the second activation time.

The indication may be received, for example, via a system information block (SIB).

A WTRU may be configured to perform a method that includes one or more of the following steps. In some examples, the method may include receiving configuration information. The configuration information may include, for example, a plurality of associated identification (ID) groups, one or more associated identifiers (IDs) associated with each associated ID group of the plurality of associated ID groups, and/or a plurality sets of radio resource control (RRC) configurations, where each set of RRC configurations is associated with an associated ID. The may include receiving indication that an associated ID group of the plurality of associated ID groups is associated with one or more cells. The method may include activating a first cell using a first set of RRC configurations of the plurality of sets of RRC configurations. The method may include receiving an activation message to activate a second cell. The method may include performing an activation procedure to activate the second cell based on the associated ID groups associated with the first cell and the second cell and based on the associated ID for the second cell. The indication may be received, for example, via a system information block (SIB).

In some examples, to perform the activation procedure, the method may include activating the cell using the first set of RRC reconfigurations upon a condition that the first associated ID group of the second cell may be the same as a second associated ID group of a third cell.

The third cell may be, for example, the first cell, a primary cell (Pcell) and/or a primary secondary group cell (PScell) that the WTRU received via the second activation message.

In some examples, in performing the activation procedure, the method may include activating the associated ID in accordance with a first activation time, wherein the first activation time is substantially immediately. In some examples, substantially immediately may be defined as immediately with some inherent latency.

In some examples, in perform the activation procedure, the method may include receiving a delta configuration and activating the cell based on the delta configuration upon a condition that a first associated ID group is not the same as a second associated ID group.

The delta configuration may be, for example, the difference between a reference configuration and a RRC configuration to be used for the second cell.

The reference configuration may be, for example, the sets of RRC configurations associated with one or more common associated IDs associated with both the first associated ID group and the second associated ID group of the plurality of associated ID groups when a number of the one or more common associated IDs is greater than an associated ID threshold.

The reference configuration may be, for example, RRC configuration without the sets of RRC configurations associated with the one or more associated IDs when a number of one or common associated IDs associated with both the first associated ID group and the second associated ID group of the plurality of associated ID groups is less than an associated ID threshold.

In some examples, the method may include activating the associated ID with a second activation time. In some examples, the first activation time may be shorter than the second activation time.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flowchart illustrating an example procedure for Determination of applicability of AI/ML models based on sub-associated IDs according to an embodiment.

FIG. 3 is a flowchart illustrating an example procedure for Life Cycle Management for multiple associated IDs according to an embodiment.

### DETAILED DESCRIPTION

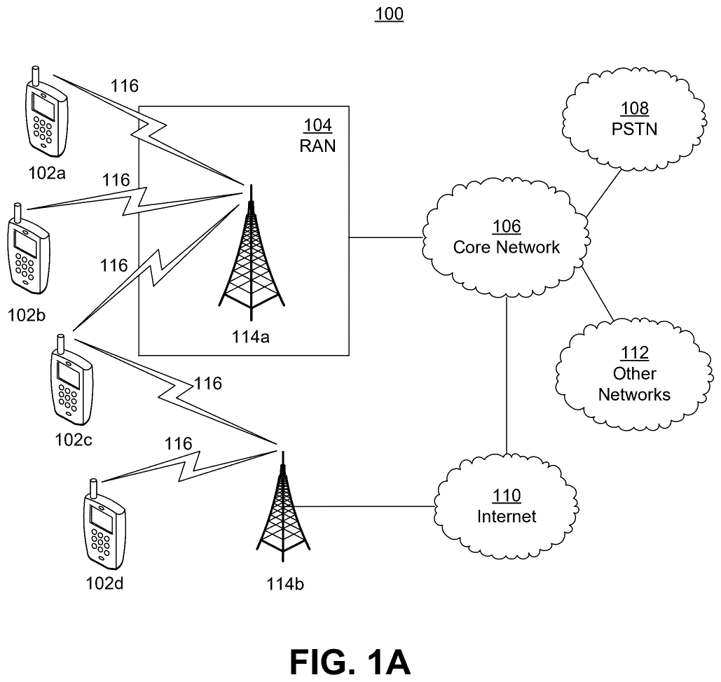

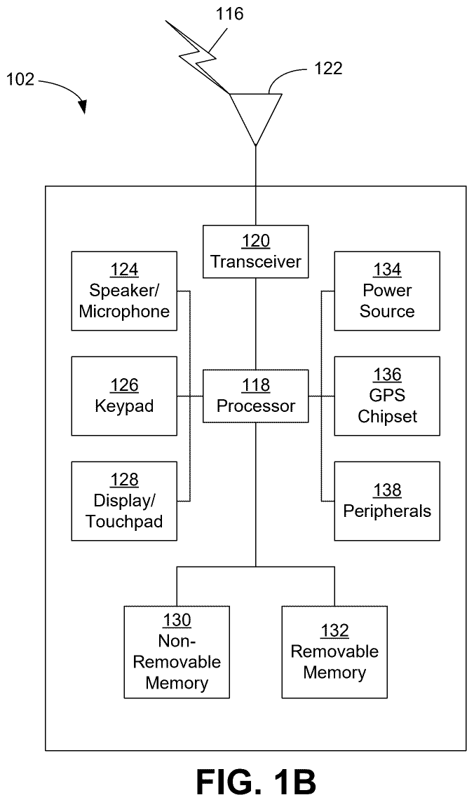

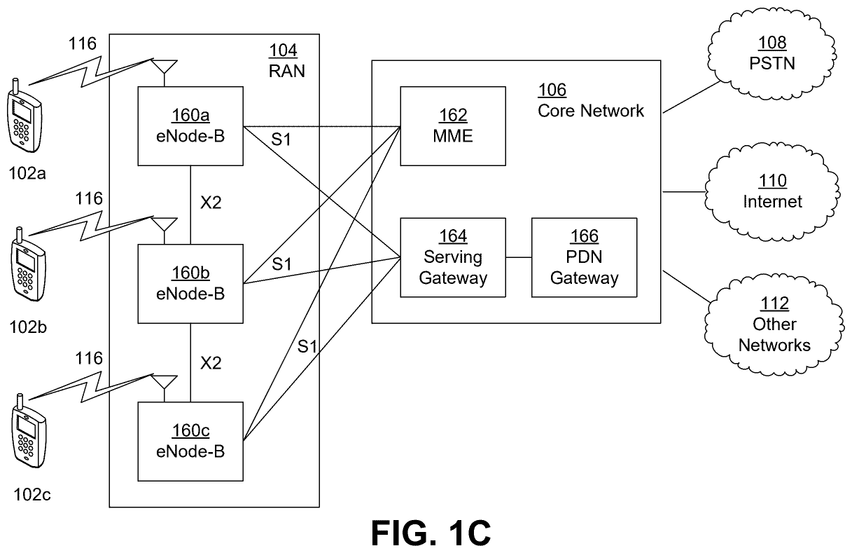

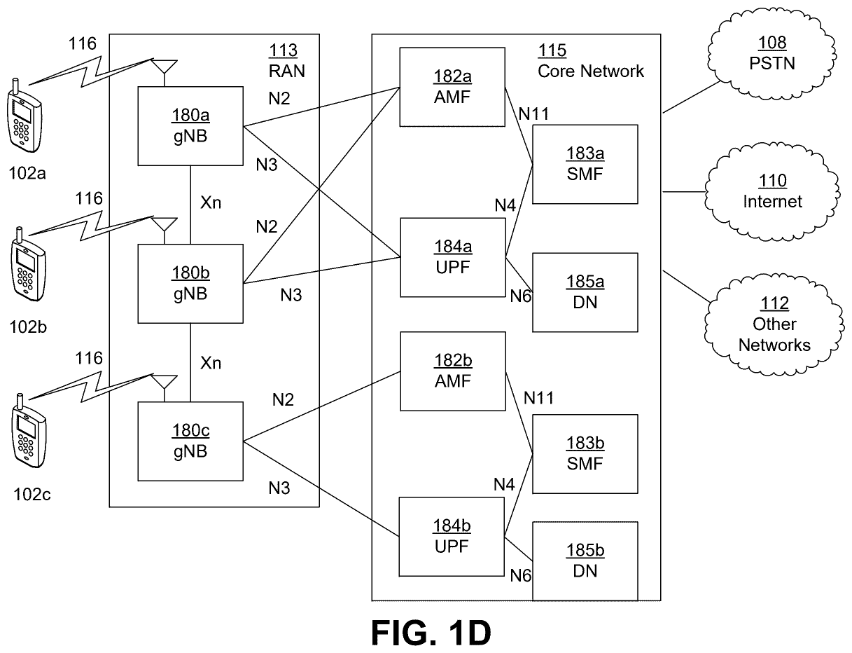

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A Radio Resource Control (RRC) reconfiguration procedure may be implemented. The WTRU may activate a cell without RRC reconfiguration if a cell is activated with an already activated associated group ID. If different associated group ID is used, the WTRU activates a RRC reconfiguration procedure based on associated IDs for previously activated cells and newly activated cells.

Life cycle management may be implemented. For example, the WTRU may evaluate the performance of a cell. If the performance does not satisfy a performance threshold, then the WTRU may determine a recovery procedure based on a cell type (e.g., indicates a new associated ID for Secondary cells (Scells) and falls back to non-AI/ML mode and support an associated ID recovery procedure for the Primary cell (Pcell).

The WTRU may determine an activation procedure of an associated ID based on associated ID group for multiple cells and support RRC reconfiguration procedure based on the associated ID group.

For example, the WTRU may receive a configuration. The configuration may be one or more associated ID groups and/or tracking areas. The configuration may be one or more associated IDs associated with each associated ID group. The configuration may be one or more sets of RRC configurations where each set of RRC configuration may be associated with each associated ID. The WTRU may receive an indication of an associated ID group associated with each cell (e.g., via system information block (SIB)). The WTRU may receive an activation message for a cell of the one or more cells and a set of associated IDs. The WTRU may determine an activation procedure of the cell based on the associated ID group and the associated IDs associated with the cell. For instance, if the associated ID group of the cell is equal to an associated ID group of previously activated cells, the WTRU may activate the associated ID without RRC reconfiguration and a first activation time (e.g., immediately).

For instance, if the associated ID group of the cell does not equal the associated ID group of the previously activated cells, the WTRU may activate the cell based on one or more of the following. For example, if the number of associated IDs which are same with the previously activated associated IDs among the set of associated IDs is greater than an associated ID threshold, the WTRU receives a delta configuration associated with different associated IDs with one or more of the following reference configurations (e.g., in associated ID level). For instance, the reference configurations may be the RRC configuration of the previously activated cell except for the RRC configuration associated with the different associated IDs. The reference configurations may be the RRC configuration associated with the same associated ID for both cells. The reference configurations may be that after the RRC reconfiguration, the WTRU activates the associated ID with a second activation time (e.g., short activation time/short delta time). For example, if the number of associated IDs which are same with the previously activated associated IDs among the set of associated IDs is less than the associated ID threshold, the WTRU receives a delta configuration associated with the set of associated IDs. (e.g., in associated ID group level).

The examples may enable the WTRU to identify whether previously applied associated ID(s) are applicable based on an associated group ID and/or receive efficient RRC reconfigurations based on the identification.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

Artificial intelligence may be broadly defined as the behavior exhibited by machines. Such behavior may e.g., mimic cognitive functions to sense, reason, adapt and act.

Machine learning may refer to type of algorithms that solve a problem based on learning through experience (‘data’), without explicitly being programmed (‘configuring set of rules’). Machine learning may be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some examples, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning may refer to a class of machine learning algorithms that employ artificial neural networks (e.g., DNNs) which were loosely inspired from biological systems. Deep Neural Networks (DNNs) are a special class of machine learning models inspired by human brain wherein the input is linearly transformed and pass-through non-linear activation function multiple times. DNNs may consists of multiple layers where each layer consists of linear transformation and a given non-linear activation functions. The DNNs may be trained using the training data via back-propagation algorithm. DNNs have shown state-of-the-art performance in variety of domains, e.g., speech, vision, natural language etc. and for various machine learning settings supervised, un-supervised, and semi-supervised. The term AI/ML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

A WTRU may transmit or receive a physical channel or reference signal according to at least one spatial domain filter. The term “beam” may be used to refer to a spatial domain filter. The WTRU may transmit a physical channel or signal using the same spatial domain filter as the spatial domain filter used for receiving a reference signals (RS) (such as channel state information (CSI)-RS) or a synchronization signals (SS) block. The WTRU transmission may be referred to as “target”, and the received RS or SS block may be referred to as “reference” or “source”. For example, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC and/or signaled by medium access control control element (MAC CE) or downlink control information (DCI). For example, a WTRU may implicitly transmit physical uplink shared channel (PUSCH) and Demodulation Reference Signals (DM-RS) of PUSCH according to the same spatial domain filter as a Sounding Reference Signal (SRS) indicated by an SRS resource indicator (SRI) indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as physical downlink control channel (PDCCH) or physical downlink shared channel (PDSCH) and its respective DM-RS. When the first and second signals are reference signals, such association may exist when the WTRU is configured with a quasi-colocation (QCL) assumption type D between corresponding antenna ports. Such an association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

A transmission and reception point (TRP) may be interchangeably used with one or more of transmission point (TP), reception point (RP), radio remote head (RRH), distributed antenna (DA), base station (BS), a sector (e.g., of a BS), and a cell (e.g., a geographical cell area served by a BS), and is still consistent with this invention. Multi-TRP may be interchangeably used with one or more of MTRP, M-TRP, and multiple TRPs, and is still consistent with this invention.

A WTRU may report a subset of channel state information (CSI) components, where the CSI components may correspond to a CSI-RS resource indicator (CRI). CSI components may correspond to a synchronization signal block (SSB) resource indicator (SSBRI). CSI components may correspond to an indication of a panel used for reception at the WTRU (e.g., a panel identity or group identity). CSI components may correspond to measurements such as layer one reference signal received power (L1-RSRP), layer one signal to interference plus noise ration (L1-SINR) taken from the SSB and/or CSI-RS (e.g., cri-RSRP, cri-SINR, ssb-Index-RSRP, ssb-Index-SINR). CSI components may correspond to other channel state information such as at least rank indicator (RI), channel quality indicator (CQI), precoding matrix indicator (PMI), Layer Index (LI), etc.

Channel and/or interference measurements may include SSB. A WTRU may receive a synchronization signal/physical broadcast channel (SS/PBCH) block. The SS/PBCH block (SSB) may include a primary synchronization signal (PSS), secondary synchronization signal (SSS), and/or a physical broadcast channel (PBCH). The WTRU may monitor, receive, or attempt to decode a SSB during initial access, initial synchronization, radio link monitoring (RLM), cell search, cell switching, etc.

Channel and/or interference measurements may include CSI-RS. A WTRU may measure and report the channel state information (CSI), wherein the CSI for each connection mode may include and/or be configured with one or more of following. For example, the CSI for each connection mode may include and/or be configured with a CSI report configuration. The CSI report configuration may include CSI report quantity, (e.g., Channel Quality Indicator (CQI), Rank Indicator (RI), Precoding Matrix Indicator (PMI), CSI-RS Resource Indicator (CRI), Layer Indicator (LI), etc.). The CSI report configuration may include a CSI report type (e.g., aperiodic, semi persistent, and/or periodic). The CSI report configuration may include a CSI report codebook configuration (e.g., Type I, Type II, Type II port selection, etc.). The CSI report configuration may include a CSI report frequency.

The CSI for each connection mode may include and/or be configured with a CSI-RS resource set. The CSI-RS resource set may include CSI resource settings, such as NZP-CSI-RS Resource for channel measurement. In another example, the CSI-RS resource set may include CSI resource settings such as NZP-CSI-RS Resource for interference measurement. In another example, the CSI-RS resource set may include CSI resource settings such as CSI-IM Resource for interference measurement.

The CSI for each connection mode may include and/or be configured with NZP CSI-RS Resources, including one or more of the following. For example, NZP CSI-RS Resources may include a NZP CSI-RS Resource ID. NZP CSI-RS Resources may include periodicity and offset. NZP CSI-RS Resources may include QCL Info and TCI-state. NZP CSI-RS Resources may include Resource mapping, e.g., number of ports, density, CDM type, etc.

A WTRU may indicate, determine, and/or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included. For example, SS reference signal received power (SS-RSRP) may be measured based on the synchronization signals (e.g., demodulation reference signal (DMRS) in physical broadcast channel (PBCH) or secondary synchronization signal (SSS)). SS-RSRP may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

Synchronization signals (SS) signal-to-noise and interference ratio (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured orthogonal frequency division multiplexing (OFDM) symbols and bandwidth. The power contribution may be received from different resources (e.g., co-channel serving and non-serving cells, adjacent channel interference, thermal noise, etc.).

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, etc.).

Sounding reference signals RSRP (SRS-RSRP) may be measured based on the linear average over the power contribution of the resource elements (RE) that carry the respective SRS.

A Beam and/or CSI report configuration (e.g., CSI-ReportConfigs) may be associated with a single Bandwidth Parts (BWP) (e.g., indicated by BWP-Id), where one or more of the following parameters are configured. For example, CSI-RS resources and/or CSI-RS resource sets for channel and interference measurement may be configured. CSI-RS report configuration type including the periodic, semi-persistent, and aperiodic may be configured. CSI-RS transmission periodicity for periodic and semi-persistent CSI reports may be configured. CSI-RS transmission slot offset for periodic, semi-persistent and aperiodic CSI reports may be configured. CSI-RS transmission slot offset list for semi-persistent and aperiodic CSI reports may be configured. Time restrictions for channel and interference measurements may be configured. Report frequency band configuration (e.g., wideband/subband CQI, PMI, etc.) may be configured. Thresholds and modes of calculations for the reporting quantities (e.g., CQI, RSRP, SINR, layer indicator (LI), RI, etc.) may be configured. Codebook configuration may be configured. Group based beam reporting may be configured. CQI may be configured. Subband size may be configured. Non-PMI port indication may be configured. Port index may be configured. Other parameters may be configured.

A CSI-RS Resource Set (e.g., NZP-CSI-RS-ResourceSet) may include one or more of CSI-RS resources (e.g., NZP-CSI-RS-Resource and CSI-ResourceConfig), where a WTRU may be configured with one or more of the following in a CSI-RS Resource. For example, a WTRU may be configured with CSI-RS periodicity and slot offset for periodic and semi-persistent CSI-RS Resources. A WTRU may be configured with CSI-RS resource mapping to define the number of CSI-RS ports, density, CDM-type, OFDM symbol, and/or subcarrier occupancy. A WTRU may be configured with the bandwidth part to which the configured CSI-RS is allocated. A WTRU may be configured with the reference to the transmission configuration indicator (TCI)-State including the quasi-co-location (QCL) source RS(s) and the corresponding QCL type(s).

One or more configurations may be used for RS resource set. For example, a WTRU may be configured with one or more RS resource sets. The RS resource set configuration may include one or more of following. For example, the RS resource set may include RS resource set ID. The RS resource set may include one or more RS resources for the RS resource set. The RS resource set may include repetition (e.g., on or off). The RS resource set may include aperiodic triggering offset (e.g., one of 0-6 slots). The RS resource set may include tracking reference signal (TRS) info (e.g., true or not).

One or more configurations may be used for RS resource. For example, a WTRU may be configured with one or more RS resources. The RS resource configuration may include one or more of following. For example, the RS resource configuration may include RS resource ID. The RS resource configuration may include resource mapping (e.g., REs in a physical resource block (PRB)). The RS resource configuration may include power control offset (e.g., one value of −8, . . . , 15). The RS resource configuration may include power control offset with SS (e.g., −3 dB, 0 dB, 3 dB, 6 Db). The RS resource configuration may include scrambling ID. The RS resource configuration may include periodicity and offset. The RS resource configuration may include QCL information (e.g., based on a TCI state).

A property of a grant or assignment may consist of at least one of the following. For example, a property of a grant or assignment may consist of a frequency allocation. A property of a grant or assignment may consist of an aspect of time allocation (e.g., a duration). A property of a grant or assignment may consist of a priority. A property of a grant or assignment may consist of a modulation and coding scheme. A property of a grant or assignment may consist of a transport block size. A property of a grant or assignment may consist of a number of spatial layers. A property of a grant or assignment may consist of a number of transports blocks. A property of a grant or assignment may consist of a TCI state, CRI or SRI. A property of a grant or assignment may consist of a number of repetitions. A property of a grant or assignment may consist of whether the repetition scheme is Type A or Type B. A property of a grant or assignment may consist of whether the grant is a configured grant type 1, type 2 or a dynamic grant. A property of a grant or assignment may consist of whether the assignment is a dynamic assignment or a semi-persistent scheduling (e.g., configured) assignment. A property of a grant or assignment may consist of whether the assignment is a configured grant index or a semi-persistent assignment index. A property of a grant or assignment may consist of a periodicity of a configured grant or assignment. A property of a grant or assignment may consist of a channel access priority class (CAPC). A property of a grant or assignment may consist of a parameter provided in a DCI, by MAC or by RRC for the scheduling the grant or assignment.

An indication by DCI may consist of at least one of the following. For example, an indication by DCI may consist of an explicit indication by a DCI field or by radio network temporary identifier (RNTI) used to mask the cyclic redundancy check (CRC) of the PDCCH. An indication by DCI may consist of an implicit indication by a property such as DCI format, DCI size, Coreset or search space, Aggregation Level, first resource element of the received DCI (e.g., index of first Control Channel Element), where the mapping between the property and the value may be signaled by RRC or MAC.

RS may be interchangeably used with one or more of RS resource, RS resource set, RS port and RS port group, and still consistent with this invention. RS may be interchangeably used with one or more of SSB, CSI-RS, SRS, DM-RS, TRS, PRS, and/or Phase Tracking RS (PTRS), and still consistent with the embodiments disclosed herein. RS may be interchangeably used with one or more of following and still be consistent with the embodiments disclosed herein. For example, RS may be interchangeably used with Sounding reference signal (SRS). RS may be interchangeably used with Channel state information-reference signal (CSI-RS). RS may be interchangeably used with Demodulation reference signal (DM-RS). RS may be interchangeably used with Phase tracking reference signal (PT-RS). RS may be interchangeably used with Synchronization signal block (SSB).

A channel may be interchangeably used with one or more of following and still consistent with this invention. For example, a channel may be interchangeably used with PDCCH. A channel may be interchangeably used with PDSCH. A channel may be interchangeably used with Physical uplink control channel (PUCCH). A channel may be interchangeably used with Physical uplink shared channel (PUSCH). A channel may be interchangeably used with Physical random access channel (PRACH).

A key performance indicator (KPI) may refer to, but not limited to, one or more of the following. For example, a KPI may refer to signal quality (e.g., L1-RSRP, SINR, CQI, RSSI, RSRQ). A KPI may refer to prediction performance (e.g., percentage of the Top-1 best beam is one of the Top-K predicted beams). A KPI may refer to Link quality (e.g., throughput, block error rate (BLER)). A KPI may refer to data distribution (e.g., mean and/or variance of measured and/or predicted beam measurements). A KPI may refer to RSRP (e.g., L1-RSRP) difference (i.e., the difference between measured and predicted RSRP of a beam).

A signal, channel, and/or message (e.g., as in DL or UL signal, channel, and/or message) may be used interchangeably, and still be consistent with this invention.

A RS resource set may be interchangeably used with a RS resource and/or a beam group, and still be consistent with this invention.

Beam reporting may be interchangeably used with CSI measurement, CSI reporting and/or beam measurement, and still be consistent with this invention.

The examples for beam resources prediction may be used for beam resources belonging to a single or multiple cells as well as single or multiple TRPs, and still be consistent with this invention.

CSI reporting may be interchangeably used with CSI measurement, beam reporting and/or beam measurement, and still consistent with this invention.

A RS resource set may be interchangeably used with a beam group, and still be consistent with this invention.

A Set B may be interchangeably used with a set of RS resource sets, beams, beam-pairs, beam RS resources, RS resources and/or a beam pattern. Set B may be interchangeably used with measurement RS resources, measurement RS resource set, measurement beam resources, measurement beam resource set, measurement beam pattern, measurement TCI states, measurement TCI state group and/or etc., and still be consistent with this invention.

A Set A may be interchangeably used with a set of RS resource sets, beams, beam-pairs, beam RS resources, RS resources, and a beam pattern, and still be consistent with the examples described herein.

Beam prediction accuracy may be interchangeably used with prediction accuracy, and still be consistent with the examples described herein.

There is some WTRU capability communication between the WTRU and the network about the WTRU's AI/ML capability (e.g., where the WTRU can indicate to the network the supported AI/ML models/functions, confidence level of predictions, time horizon of predictions (how far along in the future are the prediction being made), etc.,). The WTRU may support several AI/ML models for a certain functionality (e.g., with different prediction time horizons, prediction confidence levels, processing requirements, trained under/for operation in different frequencies/cells/location/limes of day, etc.,). A given AI/ML model may operate in different modes (e.g., with different levels of prediction confidence levels at different prediction time horizons, at different locations, frequencies, WTRU mobility pattern/speed, etc.,) The AI/ML models may be available at the WTRU already trained, and/or the WTRU may be provided with an untrained AI/ML model and performs the training by itself.

The AI/ML model may be available at the WTRU already trained, and the WTRU may be enabled/configured to perform further training (e.g., for different conditions such as frequencies/cells/location/times of day, for the same conditions as the initial training but for increasing the level of confidence or/and the prediction time horizon, for different WTRU speeds, etc.,). The AI/ML model may be available at the WTRU but not trained at all or trained for certain WTRU/network conditions, and WTRU may be configured to train the model (e.g. for the conditions that it is not trained for).

The WTRU may require some configurations/inputs that it needs for performing the inference using an AI/ML model. For example, for beam prediction, the WTRU may be configured with a certain number of beams to measure to measure other beams (e.g., set A/B configuration referred to above). In some examples, the WTRU may communicate the required configuration/input as part of the capability information. In other examples, the required configuration/input may be communicated to the network after capability request (e.g., based on explicit network request, if the WTRU gets configured to do AI/ML based beam management (BM) operations and it has determined that it is lacking the required configuration/input, etc.,).

A given AI/ML functionality may be associated with a set of KPI (Key Performance Indicators) or metrics. For example, this may be prediction accuracy, average or mean square difference between measured and predicted values etc. (e.g., for the beam prediction, these may be the beam prediction accuracy and/or confidence level, L1 RSRP difference between the measured and predicted beam signal levels, etc.,). A WTRU may have one or more AI/ML models for a given functionality, and each may have performance levels that meet different KPI thresholds (e.g., WTRU may have two models, where one has an accuracy level of 90% and another one with an accuracy level of 95%, etc.,) and it may inform the network during its capability reporting or after the capability reporting.

Consistency between training and inference may be implemented. A given AI/ML model may be trained under certain WTRU and network side additional conditions. For example, a WTRU side condition could be the speed of the WTRU. Otherwise, network side additional conditions may be something that may be related to some network configurations/settings that the WTRU may not be aware of but may impact the performance of the model. For example, an AI/ML beam management model may perform differently if it is trained when the network was using a certain antenna pattern, beam pattern, power levels, and so on. Also, there could be aspects related to network load, that may have impact on the model performance.

Since the WTRU may not need to know all the details of the network side additional conditions (and network may also not want to expose some of these implementations), the network may hide these details by signaling to the WTRU one or more associated ID(s). For example, when data is being collected for training a model, tagging may be performed indicating under which network side additional conditions the model is being trained. When a WTRU is being configured to perform an AI/ML operation, the WTRU may be configured to check the consistency between the conditions under which the AI/ML model is trained on and current conditions (e.g., current WTRU conditions, current associated ID(s) signaled by the network indicating current network conditions/settings, etc.,)

In the embodiment descriptions herein, when we refer to the full or partial validity/applicability of an associated ID, it is meant to indicate whether the WTRU has an AI/ML model/functionality that is valid/applicable for the concerned associated ID (e.g., the network may signal the same associated ID(s) to multiple WTRU), and a first WTRU may determine it to be fully applicable, a second WTRU may determine it to be partially applicable and a third WTRU may determine it to be not applicable at all.

The term Life cycle management (LCM) is used to describe the overall management aspects of AI/ML models. For example, LCM is used to describe model training. LCM is used to describe Functionality/model identification. LCM is used to describe Model delivery/transfer. LCM is used to describe Model inference operation. LCM is used to describe Functionality/model selection, activation, deactivation, switching, and fallback operation (e.g. decision by the network (either network initiated or UE-initiated and requested to the network), decision by the WTRU (event-triggered as configured by the network, WTRU's decision reported to the network, or WTRU-autonomous either with WTRU's decision reported to the network or without it)). LCM is used to describe Functionality/model monitoring. LCM is used to describe Model update. LCM is used to describe WTRU capability. LCM is used to describe Data collection (e.g., for model training, monitoring, and/or inference, etc.,)

LCM may be functionality-based LCM or model-ID based LCM. For example, in functionality-based LCM, the network may indicate activation, deactivation, fallback, and/or switching of AI/ML functionality via 3GPP signaling (e.g., RRC, MAC-CE, DCI). Models may not be identified at the network, and WTRU may perform model-level LCM. The WTRU may have one AI/ML model for the functionality, and/or the WTRU may have multiple AI/ML models for the functionality.

For example, in model-ID-based LCM, models may be identified at the network, and network and/or WTRU may activate, deactivate, select and/or switch individual AI/ML models via model ID.

For example, in functionality-based LCM, the WTRU may choose the AI/ML model to use for a certain functionality (e.g., network decides for which functionalities the WTRU can use AV/ML based operation, and the WTRU chooses the AIML model to use). In the model-ID based LCM, the network may explicitly control which particular model is used for a given AIML functionality. For example, the WTRU may provide details of AI/ML models and their capabilities, and the network may determine which model to activate for a particular functionality.

The descriptions enclosed herein may be applicable to both model-ID based and functionality-based LCM. That is, the examples may be related to how the WTRU determines whether it has a model that is applicable for the indicated associated ID(s). For example, in the case of functionality-based LCM, the WTRU may be configured and/or requested to determine if a given functionality is valid and/or applicable, and it may do the determination among all the models it has for a given functionality and may consider the functionality applicable if at least one of the models is applicable. In another example, in the case of model-ID based LCM, the WTRU may be configured and/or requested by the network to determine whether a particular model is applicable or not.

In some examples, an associated ID may be related to network configuration and/or implementation (e.g., WTRU will use that associated ID just for ensuring consistency between training and inference, as described herein).

In some examples, an associated ID may inform the WTRU (e.g., implicitly or explicitly) the configuration and/or information the WTRU needs for performing the data collection for inference. For example, the WTRU may be provided with several data collection related configurations, each indexed with an associated ID, and when the WTRU is provided with the associated ID, the WTRU may choose and/or apply the data collection configuration that corresponds with the associated ID and perform the measurements and/or logging according to this configuration.

In some examples, an associated ID informs the WTRU (e.g., implicitly or explicitly) the configuration and/or information the WTRU needs for performing the inference operation using an AI/ML model and/or functionality. For example, the WTRU may be provided with several inference configuration (e.g., set A/B configurations), each indexed with an associated ID, and when the WTRU is provided with the associated ID, the WTRU will choose and/or apply the inference configuration when using the AI/ML model and/or functionality.

In some examples, an associated ID corresponds to a particular functionality only (e.g., beam management). In some examples, an associated ID corresponds to more than one functionality (e.g., beam management and CSI prediction). In some examples, the WTRU may be configured with a group associated ID, and several individual associated IDs within the group. In some examples, an individual associated ID may belong to only one associated ID group. In some examples, an individual associated ID may belong to more than one associated ID group.

For example, the following illustrates the grouping where some associated IDs belong to only one group while the other associated IDs belong to more than one group:

| Associated ID group 1 | Associated ID group 2 |
|---|---|
| Associated ID A | Associated ID C |
| Associated ID B | Associated ID D |
| Associated ID C | Associated ID E |

In some examples, the WTRU may be configured with several cells (e.g., carrier aggregation of several cells belonging to the same base station, dual connectivity among several cells belonging to different base stations, etc.,), and an associated ID group may be configured that corresponds to the group of cells, and individual associated IDs may be configured for each cell within the group.

In some examples, the WTRU may receive the configuration of the individual associated IDs and/or the group associated ID, via dedicated signalling (e.g., in the cell group configuration of the RRC reconfiguration message). The WTRU may receive the configuration of the individual associated IDs and/or the group associated ID via broadcast signalling (e.g., in one of the SIBs and/or system information broadcast information elements). The WTRU may receive the configuration of the individual associated IDs or the group associated ID in a cell activation message (e.g., the MAC CE that is activating the cells). The WTRU may receive the configuration of the individual associated IDs or the group associated IDs in a DCI. The WTRU may receive a message to change and/or modify the individual associated IDs or the group associated IDs, according to any of the examples descried herein (i.e., RRC reconfigurations, SIB broadcast change, a MAC CE, DCI, etc.,)

In some examples, the group associated ID may not be for all the cells the WTRU is configured with, but for a subset of the cells. For example, one associated ID group may be for the cells of the primary cell group and another associated ID group for the secondary cell group, if the WTRU is operating in dual connectivity. For example, a given associated ID group may be for the cells operating at a certain frequency ranges. A given associated ID group may be for the cells operating at a certain bandwidth ranges. A given associated ID may be for a particular sets of cells (e.g., associated ID group 1 for cells A, B, C, associated ID group 2 for cells E, F, and so on, where the grouping decision is based on network implementation).

In some examples, the WTRU may be configured to consider a given cell to have a certain associated ID and a certain associated group ID. The WTRU may be configured to consider a given cell to have only a group associated ID. The WTRU may be configured to consider a given cell to have only an individual associated ID but no group associated ID.

In some examples, each cell may broadcast (e.g., in the SIB) an individual associated ID and/or a group associated ID (e.g., some WTRUs may broadcast both, some only the individual associated ID, some both the individual and group associated ID). Each cell may broadcast an individual associated ID and the WTRU may be configured separately (e.g., via RRC message, MAC CE, etc.,) that maps the individual associated IDs to group associated IDs (E.g., a mapping table). In some examples, the associated ID broadcasted by each cell may implicitly tell the group and individual associated IDs (e.g, the first x bits of the associated ID contain group information, the rest indicate the individual associated ID). For example, assuming the associated ID field has 10 bits, the first 4 bits may be referring to the group while the rest 6 refer to the individual ID. For example, if the first 4 bits are of a certain patter (e.g., 0000, or 1111), the UE may consider that this associated ID does not belong to any group. In some examples, the previous examples may be implemented with dedicated signalling instead of broadcast signalling (e.g., the individual and/or group associated IDs configured along with the RRC reconfiguration that contains the cell group configurations).

A certain cell may have several associated IDs corresponding to it. For example, the cell may have different associated IDs for different AI/ML functionalities. In another example, the cell may have several associated IDs that are corresponding to the same AI/ML functionality, but only one of them are active at a time (e.g., the WTRU may receive an indication which one is the current and/or active associated ID, e.g., in a cell activation MAC CE, in an associated ID activation/modification MAC CE or RRC message, etc.,). The terms “associated ID group”, “associated group ID”, and “group associated ID” may be used interchangeably.

The RRC protocol is used to control the WTRU's behaviour and/or actions and how it communicates with the network. This is done via RRC configurations, which is provided to the WTRU via an RRC Reconfiguration message. RRC configurations covers all aspects of the protocol layers that may be used in the communication between the WTRU and the network (e.g., RRC, PDCP, RLC, MAC, PHY) and even some higher layer configurations (e.g., non-access stratum (NAS)). In some cases, some of the configuration provided by RRC reconfiguration may be applied and/or executed immediately by the WTRU (e.g., handover, radio bearer establishment, etc.), while in other cases the WTRU may apply and/or use the configuration when a further message (e.g., lower layer indication via MAC CE or a DCI) is received indicating the activation of the configuration (e.g., a MAC CE indicating cell activation) or upon the fulfilment of a certain condition (e.g., execution of a conditional handover when the radio conditions associated with the conditional handover configuration get fulfilled).

A high-level structure of an RRC reconfiguration message may be as follows. For example:

Example RRC reconfiguration message

Information element A: value_A
Information element group B:
Information element B_1: value B_1
Information element B_2: value B_2

An RRC reconfiguration may contain a set of Information elements (IEs), which are also referred to as parameters, and corresponding value(s). Some information elements may be a grouping of several information elements, for example, containing related information to a particular feature and/or procedure (e.g., measurements, configuration of a particular protocol layer, etc.,).

Some information elements may be mandatory, for example, all WTRUs must receive a configuration of these mandatory IEs to operate properly (e.g., security configurations, basic measurement configuration, basic protocol layer configurations, etc.,), while others may be optional, and the information elements may be configured for some WTRUs only (e.g., depending on WTRU capability and/or preference, network capability/preference, etc.,). In some cases, an IE may have a default value (e.g., indicated in the 3GPP specifications), and if the WTRU does not receive the IE in the RRC configuration, it will consider as being configured with the default value for that IE.

An RRC configuration received by the WTRU may be a full configuration or a delta configuration. When the WTRU receives a full configuration, the WTRU may release the previous configuration and apply the new configuration (e.g., all the WTRU behaviour will be according to the latest received full configuration). With a delta configuration, a part/portion of the configuration may be modified, and the WTRU may modify this concerned part/portion. For example, the network may want to change the value of one or a few IEs, and it may be highly inefficient to signal the whole RRC configuration again just for this purpose. The network may send a delta configuration, which is a smaller message that contains only the information about the concerned parameter, and the WTRU will only modify the indicated parameter and keep using all the other parameters/configurations as before. A full RRC reconfiguration may be provided to the WTRU upon connection establishment and/or setup (e.g., going from IDLE/INACTIVE state to CONNECTED) or upon recovery from failure (e.g., RRC re-establishment after radio link failures). In other examples, (e.g., handover), the network may provide the WTRU with the delta configurations (e.g., configuring new IEs that are relevant and/or applicable in the new cell but were not in the previous cell, modifying the values of other IEs to align with the capabilities and/or preferences of the new cell, etc.,).

The concept of reference configuration is used herein. In some examples, a reference configuration may be associated with an associated group ID. The reference configuration may be a full RRC configuration. The reference configuration may be a delta RRC configuration. For example, the WTRU may be previously provided with an RRC configuration, and the reference configuration may contain information related to the AI/ML operation for the concerned functionality (i.e., a subset of the full RRC configuration being used by the WTRU). In some examples, the WTRU may be provided with delta configurations that may be relevant to a particular associated ID.

In some examples, the reference configuration may not contain the IEs that are included in the delta configurations. For example, the reference configuration may contain IEs A, B and C (with corresponding values), while the reference configuration may contain IEs D and E.

In some examples, the reference configuration and the delta configuration may have overlapping information and/or IEs. For example, the reference configuration may contain IEs A, B and C (e.g., with corresponding values), while the reference configuration may contain IEs C, and D (e.g., the value corresponding to C in this case being different from the one included in the reference configuration).

In some examples, an RRC configuration may refer to the WTRU's configuration related to AI/ML models and functionalities (e.g., configuration of measurements/inputs used for inference, configuration of reporting of the inferred outputs, configuration on the WTRU's behavior regarding the inferred outputs in different WTRU's procedures, etc.,). An RRC configuration may refer to all the of the WTRU's configuration (e.g., non-AI/ML related configurations such as legacy configurations as well as AI/ML related configurations).

In some examples, the full, reference and delta configurations described herein may be related to the total WTRU's configuration (e.g., AI/ML and non-AI/ML related). The full, reference and delta configuration described herein may be related to AI/ML related configuration. For example, when referring to the WTRU applies a full configuration, in this context it means the WTRU may modify the whole AI/ML related configuration, but it may keep using the current non-AI/ML related configuration.

The AI/ML related configuration and non-AI/ML related configuration may not be completely separate and/or segregated in the WTRU's RRC reconfiguration. For example, certain protocol layer's configuration (e.g., PHY layer) may be provided to the WTRU within an IE group, and there may be IEs within that group that are not related to AI/ML and other IEs that are related to AI/ML.

The terms “configuration” and “RRC configuration” may be used interchangeably. The terms “RRC configuration”, “RRC reconfiguration”, and “RRC signaling” may be used interchangeably.

Activation of a cell and an associated ID(s) and/or group IDs may be implemented. For example, when the WTRU receives a cell activation command, it may receive also an implicit or explicit indication on what associated ID to consider for that cell. In some examples, the WTRU may have previously received an RRC configuration for the concerned cell that has only one associated ID, and the cell activation command may not indicate an associated ID information, the WTRU may assume the associated ID indicated in the configuration to be the active associated ID. The WTRU may have previously received an RRC configuration for the concerned cell that has several associated IDs and one of them indicated and/or configured as a default and/or primary associated ID, and the cell activation command may not indicate an associated ID information, the WTRU may assume the associated ID indicated as default in the configuration to be the active associated ID.

In some examples, the WTRU may receive an indication of the associated ID to use in the cell activation command (e.g., explicit indication of the whole associated ID in the MAC CE, an indication of an index/ID of the associated ID in the RRC configuration, etc.,). The WTRU may receive an indication of several associated IDs to use in one cell activation command (e.g., in a list of associated IDs, a bitmap indicating which associated ID to activate or not, where the location of the bitmap corresponds to the index of the associated ID configuration in the RRC configuration, etc.). This indication may be to configure several associated IDs corresponding to different AI/ML functionalities at once. The WTRU may receive an indication of the associated ID(s) to activate and/or deactivate after a cell has been activated (e.g., in a MAC CE, RRC message, etc.,). The WTRU may receive an indication of associated ID(s) to activate and/or deactivate for several cells and/or associated IDs in one message (e.g., a MAC CE activating associated ID at associated ID group level, an RRC message that contains the list of the cells and the corresponding associated IDs to be activated and/or deactivated, etc.,).

In some examples, when the WTRU receives an activation of a cell and/or an associated ID, the WTRU may check if it has an AI/ML model and/or functionality that is applicable to the indicated associated ID. This is also referred to as the “associated ID being applicable” in the examples descriptions herein. The WTRU may receive an activation message that indicates activation of an associated ID group, and the WTRU may consider that to be an indication to activate all individual associated IDs that belong to this associated ID group.

In some examples, the WTRU may report applicability at an associated ID group level. The WTRU may report applicability at an individual associated ID level.

In the case of functionality-based LCM, the WTRU may consider the associated ID applicable if there is at least one AI/ML model for that functionality that meets the applicability criteria, according to any of the embodiments described herein. In the case of model-ID based LCM, the WTRU may do the determination of the associated ID's applicability for each AI/ML model for that functionality (e.g., or the WTRU may be explicitly configured to do the determination for a certain sub set of the AI/ML models), and report the non-applicability, partial applicability or (full) applicability for all the models (or the configured sub set of models) (e.g., the WTRU may send the list of the applicable models, the list of the non-applicable models, the list of the partial applicable models, etc., or a bitmap indicating which models are applicable or non-applicable, where the order in the bitmap is, for example, based on some model ID sorting order agreed upon the WTRU and the network, etc.,).

An associated ID may be unique for a certain functionality or it may be shared among multiple functionalities. For the case where an associated ID can be applicable for more than one functionality, the WTRU may do the determination of applicability for the associated ID for each of the concerned functionality according to any of the embodiments herein and indicate to the network to which of the functionalities the associated ID is applicable or not (e.g., the list of the applicable functionalities, the list of non-applicable functionalities, the list of partially applicable functionalities, etc., or using a bit map structure, similar to the one described above for the model ID based LCM, etc.,)

In some examples, the WTRU may be configured to immediately start applying the AI/ML model and/or functionality if it determines it to be applicable for the configured and/or indicated associated ID. In other examples, the WTRU may indicate the applicability to the network and waits for an indication from the network to further activate the AI/ML functionality/model.

The WTRU may be configured with a time duration and if it does not receive an indication from the network not to activate the concerned functionality and/or model (e.g., within the time duration after the reception of the associated ID activation command, within the time duration after the sending of the applicability or partial applicability indication, and/or within the time duration after the reception of a lower layer ACK indicating the reception of the application indication by the network, etc.), it may activate the concerned functionality and/or model.

In some examples, the WTRU may receive an RRC configuration related to associated ID group level and/or individual associated ID level. The WTRU may receive the RRC configuration prior to the activation of an associated ID group or an individual associated ID (according to any of the example descriptions herein), or as a response to the applicability indication the WTRU may have sent in response to the activation of a cell and/or group and/or individual associated ID.

In some examples, when the WTRU receives an indication of an activation of a group associated ID, it may apply the RRC reference configuration corresponding to the associated ID group. When the WTRU receives an indication of an activation of an individual associated ID, the WTRU may perform one of the following. For example, if it is the first time the WTRU is being configured to activate an associated ID within the group the indicated associated ID belongs to, the WTRU may first apply the reference configuration corresponding with the relevant associated ID group, followed by the delta configuration corresponding to the indicated associated ID. If the WTRU was previously configured to activate an associated ID that belongs to the same group as the indicated associated ID (or it was previously configured to activate only the group associated ID), the WTRU may apply the delta configuration corresponding to the indicated associated ID. If the WTRU was previously configured to activate an associated ID that belongs to the same group as the indicated associated ID, the WTRU may first release the delta configuration that it has previously applied corresponding to the previous associated ID, and apply the delta configuration corresponding to the current/indicated associated ID. If the WTRU was previously configured to activate an associated ID that does not belong to the same group as the indicated associated ID and/or it was previously configured to activate another associated ID group at a group level, the WTRU may first release the ‘full’ configuration related to the previous associated ID and/or associated ID group, and may apply the reference configuration related to the associated ID group that the indicated associated ID belongs to, followed by the delta configuration corresponding to the indicated associated ID.

In some examples, if the WTRU receives a configuration to activate a cell and/or with a given associated ID, and it has already activated another cell with the same associated ID, then the WTRU may not apply any reconfiguration and may use the configuration it has applied for the previous cell for AI/ML related operations (e.g., inference, data collection, etc.,).

In some examples, if the WTRU receives a deactivation of an associated ID, it may release the delta configuration it has applied corresponding to that individual associated ID but keep using the reference configuration it has applied corresponding to the associated ID group the indicated associated ID belong to. The term “release” may not mean that the WTRU will delete the configuration, the term “release” may mean that the WTRU may not use the configuration. If the WTRU receives a deactivation of an associated ID, it may release both the delta configuration it has applied corresponding that individual associated and also the reference configuration it has applied corresponding to the associated ID group the indicated associated ID belong to (e.g., the whole RRC configuration related to the concerned AI/ML functionality or functionalities that the associated ID is related to).

In some examples, if a WTRU receives a configuration to activate an associate ID, and it has received no delta configuration corresponding with that associated ID, but may have received a reference configuration corresponding to the group the associated ID belongs to, the WTRU may activate the corresponding AI/ML model and/or functionality. If a WTRU receives a configuration to activate an associate ID, and it has received no delta configuration corresponding with that associated ID but may have received a reference configuration corresponding to the group the associated ID belongs to, the WTRU may be configured to do some performance evaluation before activating the functionality. For example, the WTRU may be configured with a time duration and a performance evaluation criteria (e.g., a KPI and a corresponding threshold the KPI has to fulfill), and the WTRU may check the inferenced values of the AI/ML model and/or functionality, and it may activate the functionality and start using it instead of legacy functionality if the configured KPI(s) fulfilled the corresponding threshold(s). It may be assumed that the WTRU has been provided with the configuration that enables it to perform the inference (e.g., in the reference configuration, in another delta configuration corresponding to another associated ID that belongs to the same associated ID group, etc.,).

Some of the AI/ML functionalities that are mentioned in the descriptions herein, such as beam management, are illustrative examples, and by no means limiting to the embodiments. For example, the proposed embodiments can be used for any AI/ML functionality, as long as the functionality is to be used in a multi-TRP scenario and/or the functionality is impacted depending on whether the WTRU operates in a single TRP or multi-TRP scenario.

The proposed embodiments are equally valid to any other form of functionality that uses prediction that is not based on AI/ML (e.g. time series forecasting, interpolation methods, etc.,).

The embodiments described herein are agnostic to the kind of AI/ML model and/or technique used by the WTRU (e.g., the algorithm used, the mechanism such as neural network or what kind of neural network, e.g., depth and parameters/weights of the network, etc.,), the origins of the model (e.g., WTRU vendor, operator, network vendor, etc.,), or how and/or where the training of the model is done (e.g., the input data used for the training, where the training is performed, if the training is performed offline or online, etc.,). However, it can be assumed that the model is trained based on historical observation of one or more WTRUs' actual measurements in different WTRU and network conditions (e.g., during certain time durations of the day, during certain days of the week, at different locations, different WTRU mobility patterns/speeds, under different network conditions that are visible to the WTRU such as frequency/bandwidth, etc., under different network configurations, which may be visible to the WTRU just as a network configuration index that is provided by the network at the time of training or data collection for the training, etc.,).

The concept of sub-associated IDs described herein is not limited to just one level of grouping, where an associated ID contains a group of sub associated IDs. For example, embodiments can be envisioned where a sub-associated ID may have related sub-associated IDs of its own (i.e., several layers of grouping of associated IDs). Also, a sub-associated ID may belong to more than one associated ID. The terms “functionality” and “procedure” are used interchangeably.

Handling an associated ID and sub-associated IDs for multi-TRPs within a cell may be implemented. An associated ID group may be interchangeably used with a tracking area, a zone and/or an associated ID, and still consistent with this invention. An associated ID may be interchangeably used with a sub-associated ID, and still consistent with this invention.

A WTRU may be configured with one or more of the following (e.g., via one or more of RRC, LPP, MAC-CE, DCI and system information (e.g., MIB/SIB)). In some examples, the WTRU may be configured with a set of cells (e.g., via RRC). The WTRU may receive an activation message of one or more cells among the set of cells (e.g., via MAC CE). For example, the set of cells may be predefined. In some examples, the WTRU may be configured and/or indicated with one or more associated ID groups. For example, the one or more associated ID groups may be predefined. The one or more associated ID groups may be derived from one or more parameters (e.g., one or more of a WTRU ID, a cell ID, etc.).

In some examples, the WTRU may be configured with one or more associated IDs. For example, the WTRU may receive an activation message of a subset (e.g., one associated ID) of the one or more associated IDs for each cell and/or each associated ID group. Based on the activation message, the WTRU may activate the indicated associated IDs. In some examples, the WTRU may be configured with one or more associated IDs for each associated ID group separately. For example, the WTRU may be configured with first one or more associated IDs for a first associated ID group and second one or more associated IDs for a second associated ID group. The WTRU may receive an activation message of a subset (e.g., one associated ID) based on an activated associated ID group. For example, the WTRU may receive a first subset of the first one or more associated IDs if the first associated ID group is activated. If the second associated ID group is activated, the WTRU may receive a second subset of the second one or more associated IDs.

In some examples, the WTRU may be configured with one or more sets of RRC configurations, where each set of RRC configurations is associated with each associated ID. The WTRU may apply a set of RRC configurations based on an activated associated ID. For example, the WTRU may be configured and/or indicated with association between associated IDs and sets of RRC configurations. For example, a first associated ID may be associated with a first set of RRC configurations and a second associated ID may be associated with a second set of RRC configurations. If the WTRU is activated with the first associated ID, the WTRU may apply the first set of RRC configurations. If the WTRU is indicated to deactivate the first associated ID and/or activate the second associated ID, the WTRU may deactivate the first set of RRC configurations and/or activate and/or apply the second set of RRC configurations.

In some examples, the WTRU may be configured with one or more thresholds. For example, the WTRU may be configured with an associated ID threshold (e.g., to determine a procedure for RRC reconfiguration).

In some examples, the WTRU may be configured and/or indicated with an associated ID group (e.g., for each cell). For example, the associated ID group may be indicated (e.g., via SIB1). The configuration and/or indication may indicate an associated ID group among the configured, indicated and/or predefined one or more associated ID groups.

In some examples, the WTRU may apply the configured and/or indicated associated ID group to a cell which transmitted the configuration and/or indication of the associated ID group. In another example, one or more cells for applying the configured and/or indicated associated ID group may be indicated (e.g., together with the associated ID group). Based on the configuration and/or indication, the WTRU may apply the associated ID group to the one or more cells.

In some examples, the WTRU may receive an indication of one or more cells. Based on the activation message, the WTRU may determine one or more associated IDs for the indicated one or more cells. The determination may be based on one or more of the following. For example, the determination may be based on association with a cell ID and/or an associated ID group of an indicated cell for activation. For instance, the WTRU may be configured and/or indicated with one or more associated IDs among the configured associated IDs (e.g., via one or more of RRC, LPP, MAC CE and DCI) for each cell and/or each associated ID group. Based on the configuration/indication, the WTRU may determine the one or more associated IDs (e.g., a first cell and a second cell may be configured). In addition, the WTRU may be configured with a first associated ID group and a second associated ID group. For the first associated ID group, the first one or more associated IDs may be configured and/or activated. For the second associated ID group, the second one or more associated IDs may be configured and/or activated. If the WTRU may be indicated to activate the first cell indicating the first associated ID group, the WTRU may determine the first one or more associated IDs. If the WTRU is indicated to activate the second cell indicating the second associated ID group, the WTRU may determine the second one or more associated IDs.

For example, the determination may be based on explicit indication. The WTRU may be configured and/or indicated with one or more associated IDs to be used (e.g., together with the activation indication).

In some examples, the WTRU may determine an activation procedure for each cell based on one or more of the indicated associated ID group and the associated IDs for the indicated cells for activation. For example, one or more of the following may apply. For instance, the WTRU may determine an activation procedure for each cell based on previously activated cells and/or associated ID groups. If the associated ID group of the indicated cell for activation is equal to an associated ID group of previously activated cells, the WTRU may activate the associated ID without RRC reconfiguration and a first activation time (e.g., immediately).

If the associated ID group of the cell does not equal the associated ID group of the previously activated cells, the WTRU may activate the cell based on one or more of the following. For instance, if number of associated IDs which are same with the previously activated associated IDs among the set of associated IDs is greater than an associated ID threshold, the WTRU receives a delta configuration associated with different associated IDs with one or more of the following reference configurations (e.g., in associated ID level). For example, the reference configuration may be RRC configuration of the previously activated cell except RRC configuration associated with the different associated IDs. The reference configuration may be RRC configuration associated with the same associated ID for both cells. The reference configuration may be that after RRC reconfiguration, the WTRU may activate the associated ID with a second activation time (e.g., short activation time/short delta time).

If number of associated IDs which are same with the previously activated associated IDs among the set of associated IDs is less than the associated ID threshold, the WTRU may receive a delta configuration associated with the set of associated IDs (e.g., in associated ID group level).

Life cycle management for sub-associated IDs may be implemented. In some examples, a WTRU may be configured with one or more of the following. For example, a WTRU may be configured with one or more cells. For instance, the WTRU may be configured with one or more cells (e.g., via RRC and/or LPP). Each cell may be a first type cell (e.g., Pcell and/or PScell) or a second type cell (e.g., Scell). For instance, the WTRU may receive an activation message of a set of cells among the one or more cells (e.g., via MAC CE). In another example, the set of cells may be predefined.

In some examples, a WTRU may be configured with one or more associated ID groups (and/or tracking areas). For instance, the WTRU may be configured and/or indicated with one or more associated ID groups. For instance, the one or more associated ID groups may be predefined. For instance, the one or more associated ID groups may be derived from one or more parameters (e.g., one or more of a WTRU ID, a cell ID and etc.).

In some examples, a WTRU may be configured with one or more associated IDs. For example, the WTRU may be configured with one or more associated IDs. The WTRU may receive an activation message of a subset (e.g., one associated ID) of the one or more associated IDs for each cell and/or each associated ID group. Based on the activation message, the WTRU may activate the indicated associated IDs. For example, the WTRU may be configured with one or more associated IDs for each associated ID group separately. For instance, the WTRU may be configured with first one or more associated IDs for a first associated ID group and second one or more associated IDs for a second associated ID group. The WTRU may receive an activation message of a subset (e.g., one associated ID) based on an activated associated ID group. For instance, the WTRU may receive a first subset of the first one or more associated IDs if the first associated ID group is activated. If the second associated ID group is activated, the WTRU may receive a second subset of the second one or more associated IDs.

In some examples, a WTRU may be configured with one or more sets of RRC configurations. For example, the WTRU may be configured with one or more sets of RRC configurations where each set of RRC configurations may be associated with each associated ID. The WTRU may apply a set of RRC configurations based on an activated associated ID. For instance, the WTRU may be configured and/or indicated with association between associated IDs and sets of RRC configurations. For instance, a first associated ID may be associated with a first set of RRC configurations and a second associated ID may be associated with a second set of RRC configurations. If the WTRU is activated with the first associated ID, the WTRU may apply the first set of RRC configurations. If the WTRU is indicated to deactivate the first associated ID and/or activate the second associated ID, the WTRU may deactivate the first set of RRC configurations and/or activate and/or apply the second set of RRC configurations.

In some examples, a WTRU may be configured with one or more UL resources. For example, the WTRU may indicate prediction failure(s) and new candidate associated IDs for cells with prediction failure via one or more UL resources. The indication may be via one or more of SRS, PUCCH, PUSCH, PRACH, CSI, MAC CE, etc.

In some examples, the WTRU may be configured with one or more thresholds. For example, the WTRU may be configured with one or more performance thresholds. For example, each performance threshold may be associated with each cell and/or each associated ID.

In some examples, the WTRU may be configured with one or more DL confirmation resources. The WTRU may receive a confirmation on WTRU indication (e.g., one or more of prediction failure and new candidate associated IDs). The confirmation may be via one or more of DMRS, CSI-RS, PDCCH and PDSCH. For example, a first scrambling ID may be used for normal operation for DMRS and/or CSI-RS while a second scrambling ID may be used for confirmation. In another example, toggling of a scrambling ID (e.g., between the first scrambling ID and the second scrambling ID) may be used If the gNB receives WTRU indication.

In some examples, the WTRU may receive an activation message of a set of cells of the one or more cells. The WTRU may receive an activation message of a set of associated IDs of the one or more associated IDs.

In some examples, each cell may be associated with one or more associated IDs. If two or more associated IDs are associated with each cell, the WTRU may determine associated IDs to be activated (e.g., among the two or more associated IDs). For example, the WTRU may receive an activation message (e.g., via one or more of RRC, LPP, MAC CE and DCI) of the associated IDs. The WTRU may determine associated IDs to be activated. The determination may be based on a maximum number of activated associated IDs. For example, the WTRU may be indicated and/or configured with a maximum number of activated associated IDs (e.g., via one or more of RRC, LPP, MAC CE or DCI). In another example, the maximum number of activated associated IDs may be predefined. If number of indicated and/or configured associated IDs is greater than the maximum number of activated associated IDs, the WTRU may determine associated IDs to be activated among the two or more associated IDs for a cell to be activated (e.g., the maximum number of activated associated IDs). For example, associated IDs with lowest IDs or highest IDs among the two or more associated IDs may be activated.

In some examples, the WTRU may evaluate performance of the set of cells (e.g., activated cells) based on the set of configurations (e.g., RRC and/or LTE positioning protocol (LPP)) associated with the associated IDs (e.g., activated associated IDs for the activated cells). For example, the WTRU may evaluate performance of each cell among the set of cells by measuring RSs (e.g., configured RSs for one or more of Set A, Set B, performance monitoring or positioning in associated configurations with the cell). For performance evaluation, a performance metric may be used. The performance metric may be prediction accuracy and/or channel quality. For example, the prediction accuracy may be one or more of beam prediction accuracy, RSRP difference between predicted beams and measured beams, CSI prediction accuracy and positioning prediction accuracy. The channel quality may be one or more of (L1-)RSRP, (L1-)RSRQ, (hypothetical) PDCCH BLER, PDSCH BLER, CQI, etc.

Based on the performance evaluation, the WTRU may determine whether to trigger recovery procedure and a type of recovery procedure. For example, if performance of a cell is less than a performance threshold (e.g., prediction failure detection), the WTRU may determine to trigger the recovery procedure. A counter and/or a time window may be used for triggering recovery procedure. For example, the WTRU may increase the counter if the WTRU detects prediction failure. If the detected prediction failure equals a detection failure threshold, the WTRU may trigger the recovery procedure. In another example, if the detected prediction failures within the time window equals a detection failure threshold, the WTRU may trigger the recovery procedure.

In some examples, the WTRU may determine a type of the recovery procedure. The type of the recovery procedure may be based on a cell type. For example, if at least one cell (e.g., among cells with detected prediction failure(s)) is the first cell type (e.g., Pcell or PScell), the WTRU may activate non-AI/ML mode and/or may trigger associated ID recovery procedure. For example, the WTRU may transmit one or more UL signals (e.g., SRS or PRACH) in the one or more UL resources. Based on the one or more UL resources, the WTRU may receive one or more confirmation (e.g., via CORESETs/Search spaces (e.g., associated with the associated ID(s) associated with the cell). If all the cells (e.g., cells with detected prediction failure(s)) are the second cell type, the WTRU may indicate cell IDs of the cells with the prediction failure(s) (e.g., via one or more of MAC CE and DCI). The indication may be transmitted in one or more UL resources (e.g., associated with the associated ID(s) associated with the cell). The WTRU may indicate new candidate associated IDs for the cells with the prediction failure(s) via the indication.

Determination of applicability of AI/ML models based on sub-associated IDs may be implemented. For example, a WTRU may determine the applicability of an associated ID based on sub-associated IDs. The WTRU supports AI/ML based on the determined applicability.

In some examples, the WTRU may receive a configuration. The configuration may be one or more associated ID groups and/or tracking areas. The configuration may be one or more associated IDs associated with each associated ID group. The configuration may be one or more sets of RRC configurations where each set of RRC configuration may be associated with each associated ID. The WTRU may receive an indication of an associated ID group associated with each cell (e.g., via system information block (SIB)). The WTRU may receive an activation message for a cell of the one or more cells and a set of associated IDs. The WTRU may determine an activation procedure of the cell based on the associated ID group and the associated IDs associated with the cell. For instance, if the associated ID group of the cell is equal to an associated ID group of previously activated cells, the WTRU may activate the associated ID without RRC reconfiguration and a first activation time (e.g., immediately).

For instance, if the associated ID group of the cell does not equal the associated ID group of the previously activated cells, the WTRU may activate the cell based on one or more of the following. For example, if the number of associated IDs which are same with the previously activated associated IDs among the set of associated IDs is greater than an associated ID threshold, the WTRU receives a delta configuration associated with different associated IDs with one or more of the following reference configurations (e.g., in associated ID level). For instance, the reference configurations may be the RRC configuration of the previously activated cell except for the RRC configuration associated with the different associated IDs. The reference configurations may be the RRC configuration associated with the same associated ID for both cells. The reference configurations may be that after the RRC reconfiguration, the WTRU activates the associated ID with a second activation time (e.g., short activation time/short delta time). For example, if the number of associated IDs which are same with the previously activated associated IDs among the set of associated IDs is less than the associated ID threshold, the WTRU receives a delta configuration associated with the set of associated IDs. (e.g., in associated ID group level).

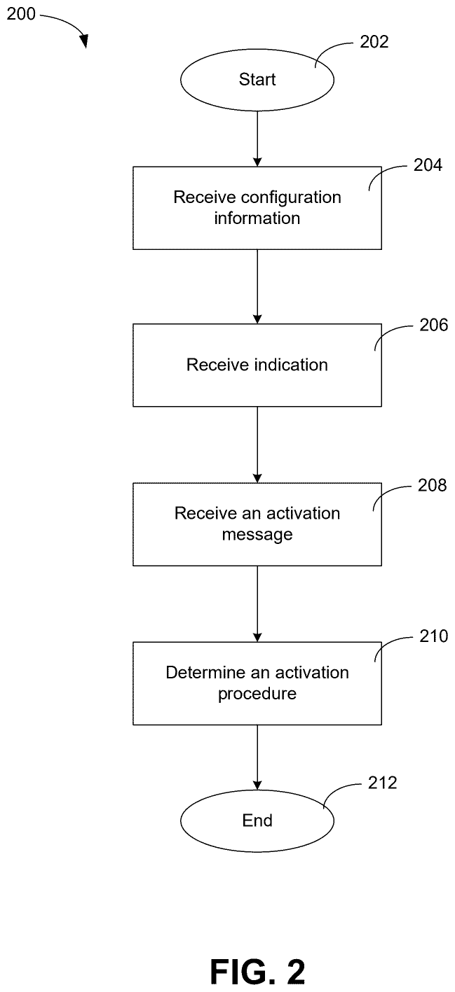

FIG. 2 is an example of a procedure 200 for determining the applicability of AI/ML models based on sub-associated IDs. The procedure 200 may be performed by a WTRU. The procedure 200 may be started at 202. At 204, the WTRU may receive configuration information. The configuration may include one or more associated ID groups and/or tracking areas. The configuration may be one or more associated IDs associated with each associated ID group. The configuration may be one or more sets of RRC configurations where each set of RRC configuration may be associated with each associated ID. The examples may enable the WTRU to identify whether previously applied associated ID(s) are applicable based on an associated group ID and/or receive efficient RRC reconfigurations based on the identification. At 206, the WTRU may receive an indication. The indication may include an associated ID group associated with each cell (e.g., via system information block (SIB)). At 208, the WTRU may receive an activation message. The activation message may be for a cell of the one or more cells and a set of associated IDs. At 210, the WTRU may determine an activation procedure of the cell based on the associated ID group and the associated IDs associated with the cell as described supra and herein. At 212, the WTRU may end the procedure.

Life cycle management for multiple associated IDs may be implemented. For example, A UE determines an activation procedure of an associated ID based on associated group ID.

In some examples, a WTRU may receive the following configuration. For example, the WTRU may receive one or more associated IDs and/or one or more sets of RRC configurations where each set of RRC configuration is associated with each associated ID. The WTRU may receive an activation message of a set of cells for the one or more cells and a set of associated IDs wherein each cell is associated with each associated ID. The WTRU may evaluate the performance of the set of cells based on the set of RRC configurations associated with the associated IDs associated with the set of cells. For instance, if the performance of a cell is less than a performance threshold and/or the cell is first cell type (e.g., Pcell or PScell), the WTRU may activate a non-AI/ML mode and may trigger an associated ID recovery procedure. For instance, if the performance of one or more cells is less than a performance threshold and the one or more cells are second cell type (e.g., Scell), the WTRU may indicate cell IDs of the one or more cells and potentially with new candidate associated IDs. The examples may enable the WTRU to monitor and recover AI/ML model based on given associated IDs and cell types.

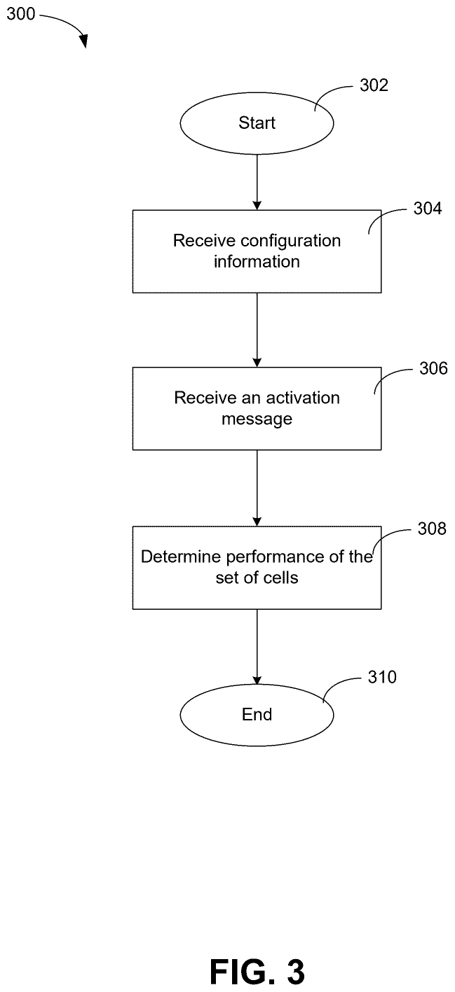

FIG. 3 is an example of a procedure 300 for life cycle management for multiple associated IDs. The procedure 300 may be performed by a WTRU. The procedure 300 may be started at 302. At 304, the WTRU may receive configuration information. The configuration may include one or more associated IDs and/or one or more sets of RRC configurations where each set of RRC configuration is associated with each associated ID. At 306, the WTRU may receive an activation message. The activation message may include a set of cells for the one or more cells and a set of associated IDs wherein each cell is associated with each associated ID. At 308, the WTRU may determine the performance of a set of cells. The determination may be based on the set of RRC configurations associated with the associated IDs associated with the set of cells as described supra and herein. At 310, the WTRU may end the procedure.

1. A wireless transceiver/receiver unit (WTRU) comprising:
a processor configured to:
receive configuration information, wherein the configuration information comprises a plurality of associated identification (ID) groups, one or more associated identifiers (IDs) associated with each associated ID group of the plurality of associated ID groups, and a plurality sets of radio resource control (RRC) configurations, wherein each set of RRC configurations is associated with an associated ID;
receive information that indicates that a first associated ID group of the plurality of associated ID groups is associated with a first cell and a second associated ID group of the plurality of associated ID groups is associated with a second cell;
activate the first cell using first set of RRC configurations of the plurality of sets of RRC configurations;
receive an activation message to activate the second cell; and
perform an activation procedure to activate the second cell based on (i) the first associated ID group associated with the first cell and the second associated ID group associated with the second cell and (ii) the associated ID for the second cell.

2. The WTRU of claim 1, wherein, to perform the activation procedure, the processor is configured to perform the activation procedure to activate the second cell based on (i) the first associated ID group associated with the first cell being the same as the second associated ID group associated with the second cell and (ii) the associated ID for the second cell.

3. The WTRU of claim 1, wherein, to perform the activation procedure, the processor is configured to activate the second cell using the first set of RRC reconfigurations upon a condition that the first associated ID group of the second cell is the same as a third associated ID group of a third cell, and wherein (i) the third cell is the first cell and the third associated ID group is the first associated ID group, (ii) the third cell is a primary cell (Pcell), or (iii) the third cell is a primary secondary group cell (PScell) that the WTRU received via the second activation message.

4. The WTRU of claim 1, wherein, to perform the activation procedure, the processor is configured to activate an associated ID of the second cell associated ID in accordance with an activation time, wherein the activation time is substantially immediately.

5. The WTRU of claim 1, wherein, to perform the activation procedure, the processor is configured to receive a delta configuration and activate the second cell the delta configuration based upon a condition that the first associated ID group of the first cell is not the same as the second associated ID group of the second cell.

6. The WTRU of claim 5, wherein the delta configuration is the difference between a reference configuration and a RRC configuration to be used for the second cell.

7. The WTRU of claim 6, wherein, when a number of one or more common associated IDs that are associated with both the first associated ID group and the second associated ID group is greater than an associated ID threshold, the reference configuration comprises the RRC configurations associated with the one or more common associated IDs.

8. The WTRU of claim 6, wherein, when a number of one or common associated IDs associated with both the first associated ID group and the second associated ID group is less than an associated ID threshold, the reference configuration comprises an RRC configuration that is not part of the the sets of RRC configurations associated with the one or more associated IDs.

9. The WTRU of claim 8, wherein the processor is configured to activate the one or more associated IDs with a second activation time that is different from activation time that is used activate an associated ID of the second cell when the first associated ID group associated with the first cell is the same as the second associated ID group associated with the second cell.

10. The WTRU of claim 1, wherein the indication is received via a system information block (SIB).

11. A method performed by a wireless transceiver/receiver unit (WTRU), the method comprising:
receiving configuration information, wherein the configuration information comprises a plurality of associated identification (ID) groups, one or more associated identifiers (IDs) associated with each associated ID group of the plurality of associated ID groups, and a plurality sets of radio resource control (RRC) configurations, wherein each set of RRC configurations is associated with an associated ID;
receiving information that indicates that a first associated ID group of the plurality of associated ID groups is associated with a first cell and a second associated ID group of the plurality of associated ID groups is associated with a second cell;
activating the first cell using first set of RRC configurations of the plurality of sets of RRC configurations;
receiving an activation message to activates a second cell; and
performing an activation procedure to activate the second cell based on (i) the first associated ID group associated with the first cell and the second associated ID group associated with the second cell and (ii) the associated ID for the second cell.

12. The method of claim 11, wherein, performing the activation procedure comprises performing the activation procedure to activate the second cell based on (i) the first associated ID group associated with the first cell being the same as the second associated ID group associated with the second cell and (ii) the associated ID for the second cell.

13. The method of claim 11, wherein, performing the activation procedure, the method comprises activating the second cell using the first set of RRC reconfigurations upon a condition that the associated ID group of the second cell is the same as a third associated ID group of a third cell, and wherein (i) the third cell is the first cell and the third associated ID group is the first associated ID group, (ii) the third cell is a primary cell (Pcell), or (iii) the third cell is a primary secondary group cell (PScell) that the WTRU received via the activation message.

14. The method of claim 11, wherein, performing the activation procedure, the method comprises activating an associated ID of the second cell in accordance with an activation time, wherein the activation time is substantially immediately.

15. The method of claim 11, wherein, performing the activation procedure, the method comprises receiving a delta configuration and activating the second cell based on the delta configuration based upon a condition that the first associated ID group of the first cell is not the same as the second associated ID group of the second cell.

16. The method of claim 15, wherein the delta configuration is the difference between a reference configuration and a RRC configuration to be used for the second cell.

17. The method of claim 16, wherein, when a number of one or more common associated IDs that are associated with both the first associated ID group and the second associated ID group is greater than an associated ID threshold, the reference configuration comprises the RRC configurations associated with the one or more common associated IDs.

18. The method of claim 16, wherein, when a number of one or common associated IDs associated with both the first associated ID group and the second associated ID group is less than an associated ID threshold, the reference configuration comprises an RRC configuration that is not part of the the sets of RRC configurations associated with the one or more associated IDs.

19. The method of claim 18, wherein the method comprises activating the one or more associated IDs with a second activation time that is different from activation time that is used activate an associated ID of the second cell when the first associated ID group associated with the first cell is the same as the second associated ID group associated with the second cell.

20. The method of claim 11, wherein the indication is received via a system information block (SIB).
